(19) United States
(12) Patent Application Publication
(10) Pub. No.: US 2010/0014744 A1
(43) Pub. Date: Jan. 21, 2010

(54) DATA READING APPARATUS, METHOD OF CONTROLLING THE SAME, AND PRINTER

(75) Inventor: Hiroyuki Inaba, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/400,047

(22) Filed: Mar. 9, 2009

(30) Foreign Application Priority Data
Jul. 16, 2008 (JP) 2008-184941

(51) Int. Cl. G06K 9/00; G06F 15/00

(52) U.S. Cl. 382/140; 358/1.18

(57) ABSTRACT

A data reading apparatus includes: a medium-transporting unit configured to transport a medium on which magnetic ink characters are printed; a reading mechanism configured to read the magnetic ink characters printed on the medium in the form of a magnetic waveform; a correction-value storage unit configured to store a correction value inherent to the data reading apparatus, the correction value having been calculated from an error determined by comparing a reference magnetic waveform acquired by reading reference magnetic ink characters printed on a reference medium in a reference data reading apparatus, with the magnetic waveform actually acquired by reading the reading mechanism; a correction unit configured to correct, by using the correction value, the magnetic waveform acquired when the reading mechanism reads the magnetic ink characters printed on the medium; and a decryption unit configured to decrypt the magnetic ink characters printed on the medium, in accordance with the magnetic waveform corrected by the correction unit.

### CROSS-REFERENCE TO RELATED APPLICATIONS

This application is based upon and claims the benefit of priority from the prior Japanese Patent Application No. 2008-184941, filed on Jul. 16, 2008, the entire contents of which are incorporated herein by reference.

### BACKGROUND OF THE INVENTION

1. Field of the Invention

The present invention relates to a data reading apparatus and a method of controlling the same. More particularly, the invention relates to a data reading apparatus that reproduces data recorded in magnetic ink on a recording medium and a method of controlling the apparatus, and to a printer that includes the data reading apparatus.

2. Description of the Related Art

Checks are widely used in commercial transactions and in buying goods at shops. Generally, various standardized data items, such as the ID number of the issuing bank, the issuer's account number, are described at designated positions on the obverse side of a check, in addition to the amount of money and issuers' signature. These data items are printed in magnetic ink in order to achieve magnetic ink character recognition (MICR) Magnetic ink character readers (MICRs) have been developed, each having a magnetic head for detecting magnetic ink characters, thereby to read the data represented by the magnetic ink characters. In any shop, any operator who has received a check uses the MICR, reading data from the check, confirming the validity of the check, and operates a printer, printing authentication and shop's name on the check, thereby endorsing the check.

Recently, an apparatus has been proposed, which has a magnetic head and a print head arranged in the same transport path to read magnetic ink characters from a check and print magnetic ink characters on the check, respectively, thereby to confirm the validity of the check and endorse the same in sequence. (Refer to, e.g., Patent Document 1: Jpn. Pat. Appln. Laid-Open Publication No. 10-083438.)

With the conventional technique disclosed in the above Patent Document 1, the transport system may malfunction while the reading system is reading magnetic ink characters. Inevitably, the reading system cannot read the magnetic ink characters correctly. The apparatus disclosed in the publication has no means for correcting errors resulting from the malfunction of the transport system. Consequently, the apparatus may not correctly reproduce or read MICR characters from the MICR recording media.

### BRIEF SUMMARY OF THE INVENTION

It is an object of the present invention to provide a data reading apparatus that can read data at an improved precision.

In an aspect of the present invention, there is provided a data reading apparatus that includes: a medium-transporting unit configured to transport a recording medium on which magnetic ink characters are printed;

a reading mechanism configured to read the magnetic ink characters printed on the recording medium in the form of a magnetic waveform;

a correction-value storage unit configured to store a correction value inherent to the data reading apparatus, the correction value having been calculated from an error determined by comparing a reference magnetic waveform acquired by reading reference magnetic ink characters printed on a reference medium in a reference data reading apparatus, with the magnetic waveform actually acquired by reading the reference medium by the reading mechanism;

a correction unit configured to correct, by using the correction value, the magnetic waveform acquired when the reading mechanism actually reads the magnetic ink characters printed on the recording medium; and

a decryption unit configured to decrypt the magnetic ink characters printed on the recording medium actually, in accordance with the magnetic waveform corrected by the correction unit.

### BRIEF DESCRIPTION OF THE DRAWINGS

FIG. 1 is a diagram showing how major components are arranged in a data reading apparatus according to an embodiment of the present invention;

FIG. 2 is a side view of the data reading apparatus;

FIG. 3 is a plane view of the data reading apparatus;

FIG. 4 is a diagram illustrating an exemplary waveform of a signal that the apparatus generates upon reading magnetic ink characters;

FIG. 5 is a block diagram showing an exemplary configuration of the data reading apparatus according to the embodiment of this invention; and

FIG. 6 is a flowchart explaining the sequence of storing the correction value in the data reading apparatus according to the embodiment of the invention.

### DETAILED DESCRIPTION OF THE INVENTION

Throughout this description, the embodiment and examples shown should be considered as exemplars, rather than limitations on the apparatus and methods of the present invention.

An embodiment of the present invention will be described with reference to the accompanying drawings. The components shown in each figure and identical to those shown in any other figure are designated by the same reference numbers and will not be described repeatedly.

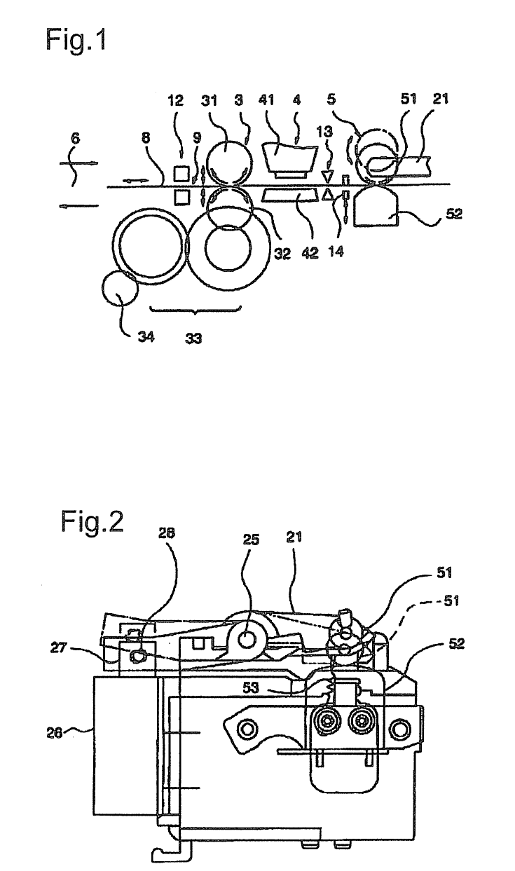

FIG. 1 is a diagram that shows how major components are arranged in a data reading apparatus.

The major components of this data reading apparatus are a transporting mechanism 3, a printing mechanism 4, and a reading mechanism 5. As shown in FIG. 1, the apparatus has an insertion port 6 made in the left side. On a sheet-transporting path 9, a sheet-transporting roller 31, a print head 41, and a pressing roller 51 are arranged in a straight line in the mentioned order.

A sheet-transporting roller 32, a platen 42 and a magnetic head 52 that is a detector are arranged in a straight line in the mentioned order, and are opposed to the sheet-transporting roller 31, print head 41 and pressing roller 51, respectively, across the sheet-transporting path 9.

The transporting mechanism 3 is composed of the sheet-transporting roller 31 and the sheet-transporting roller 32. The printing mechanism 4 is composed of the print head 41 and the platen 42. The reading mechanism 5 is composed of the pressing roller 51 and the magnetic head 52.

The sheet-transporting rollers 31 and 32 and the pressing roller 51 can move up and down. The sheet-transporting rollers 31 and 32, the pressing roller 51, and the magnetic head 52 constitute the sheet-transporting path 9. A part of the sheet-transporting path 9 can be provided in the form of an integral unit.

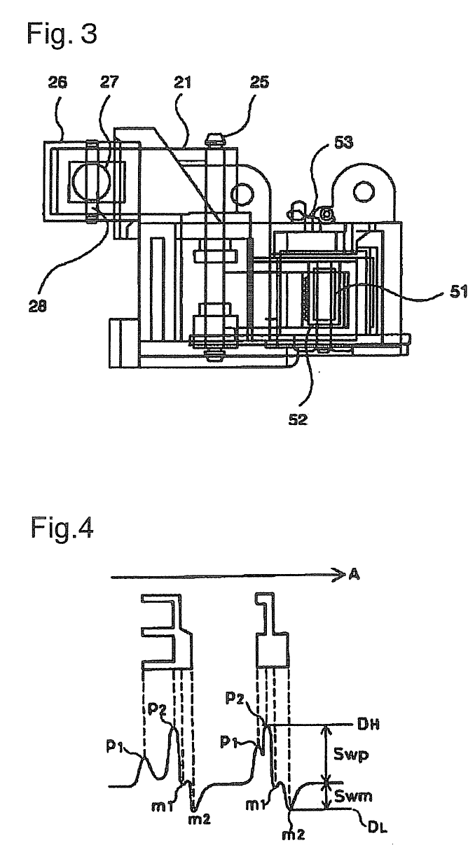

Such an integral unit is shown in FIG. 2 and FIG. 3. FIG. 2 is a side view, and FIG. 3 is a plan view. The pressing roller 51 is secured to one end of an arm 21. The other end of the arm 21 is coupled by a shaft 28 to a plunger 27. The arm 21 is supported, at middle part thereof, by a shaft 25. The arm 21 can freely rotate around the shaft 25. A vessel 26 contains a solenoid. When supplied with power, the solenoid drives the plunger 27 up and down, causing the pressing roller 51 to contact and leave the magnetic head 52. The solenoid contained in the vessel 26 can be a known self-hold solenoid. The plunger 27 is driven up or down in accordance with the direction in which power is supplied to the solenoid. When the supply of power is terminated, the plunger 27 stops and remains at the position it assumes at this moment.

In this embodiment, the pressing roller 51 moves away from the magnetic head 52 when the self-hold solenoid assumes an “attracting” state, and moves onto the magnetic head 52 when the solenoid assumes a “releasing” state. This can reduce the influence of the force the magnet exerts while the pressing roller 51 is pressing the magnetic head 52. The pressing force of the pressing roller 51 therefore has an almost constant value determined by the resilient force of a pressing spring 53.

The sequence of detecting data from a recording medium will be explained. In the initial state, the sheet-transporting rollers 31 and 32 are spaced apart from each other, whereby the transporting mechanism 3 remains in a released state. Therefore, the pressing roller 51 remains in a released state, located away from the magnetic head 52. The data reading apparatus may receive a MICR-character reading mode signal from a host apparatus. In this case, power is supplied to the self-hold solenoid. The solenoid drives the plunger 27 downwards. The pressing roller 51 is thereby moved upwards, assuming a released state. The plunger 27 is driven so that the pressing roller 51may reliably assume the released state even if an excessive external force acts on the roller 51 and the self-hold solenoid inevitably comes out of the “attracting” state.”When the plunger 27 is moved downwards, a pilot lamp, for example, emits light, indicating that the data reading apparatus can operate in normal state. Note that a detector of any known type, such as a photo-interrupter, may be used to detect one end of the arm 21, thereby to detect whether the self-hold solenoid assumes the “attracting” state.”If this is the case, the operation described above need not be performed at all.

At this point, the form stopper 14 arranged between the printing mechanism 4 and the reading mechanism 5 has already slid to its upper position, blocking the sheet-transporting path 9. When a check is inserted through the insertion port 6, its leading edge abuts on the form stopper 14. The check is thereby positioned in the data reading apparatus.

Between the insertion port 6 and the transporting mechanism 3, a sheet sensor 12 is provided to detect a check. Similarly, another sheet sensor 13 is provided between the printing mechanism 4 and the form stopper 14. If the sheet sensors 12 and 13 detect the check inserted into the sheet-transporting path 9, the sheet-transporting rollers 31 and 32 hold the check, and the form stopper 14 is slid to its lower position. The check is thereby taken from the sheet-transporting path 9. It should be noted that a mechanism for moving the sheet-transporting rollers 31 and 32 and the form stopper 14 can be constituted by a known-type mechanism, such as a plunger or a link mechanism. At this time, a stepping motor 34 is controlled, resetting a counter incorporated in a control circuit (not shown), the count of which represents the position of the sheet. The counter is so configured that its count increases or decreases in accordance with which direction and how much the shaft of the stepping motor 34 has rotated.

Next, the stepping motor 34 drives a transmission reduction mean 33, which rotates the sheet-transporting rollers 31 and 32. Thus rotated, the sheet-transporting rollers 31 and 32 further transport the check 8 to the end of the sheet-transporting path 9, conveying the check 8 into the reading mechanism 5. When the sheet sensor 12 detects the trailing edge of the check 8, i.e., rear edge thereof, the check 8 is transported further forwards by a prescribed distance. The check 8 is thereby located at a position not outside the transporting mechanism 3. Then, the sheet-transporting rollers 31 and 32 are stopped rotating. The arm 21 is moved, causing the pressing roller 51 to press the check 8 onto the magnetic head 52. Since the arm 21 is driven by the self-hold solenoid, the supply of power to the solenoid can be stopped once the check 8 has been pressed to the magnetic head 52. This can suppress the generation of magnetic noise from, for example, power-supply noise in the current or the switching noise in any other electronic device.

The check 8 is inserted, with the side, on which the designated data items are printed in magnetic ink, turned down to contact the magnetic head 52.

When the sheet-transporting rollers 31 and 32 rotate in the reverse direction, the check 8 is transported back toward the insertion port 6. At this time, the pressing roller 51 presses the check 8 onto the magnetic head 52. An appropriate friction is therefore acting on the check 8. Therefore, a tension equivalent to both this friction and the drive force of the sheet-transporting rollers 31 and 32 is exerted on the check 8. The check 8 is therefore stretched at the folds and creases, if any, rendering it easy for the check 8 to contact the magnetic head 52 firmly. To increase the tension acting on the check 8, a sliding pusher member may be provided, in place of the pressing roller 51, to generate a sliding friction between it and the check 8. Alternatively, for the same purpose, a mechanical resistance member of known type, such as a damper, may be provided to exert a viscosity resistance at the bearing of the pressing roller 51. In either case, it is desirable to locate the shaft 25, which works as the fulcrum for the arm 21, closer to the insertion port 6 than the pressing roller 51 is located. This is because the load on the bearing of pressing roller 51 acts on the arm 21, increasing the pressing force the pressing roller 51 exerts.

As the check 8 is transported back, the blank area of the check 8, in which no magnetic ink is applied, moves in contact with the magnetic head 52. Hence, the magnetic noise, both within and without the device for detecting the data stored in the recording medium, can be measured as the magnetic head 52 detects magnetism.

While the signal level of the magnetic noise is being stored, the sheet-transporting rollers 31 and 32 transport the check 8. As the ink-applied area of the check 8 passes over the magnetic head 52, the magnetic head 52 detects a signal pertaining to the magnetic ink. The signal detected by the magnetic head 52 is supplied to a signal processing circuit (not shown). The signal processing circuit performs analog-to-digital (AD) conversion on the signal, generating digital data. The digital data is stored in a storage device (not shown) at predetermined intervals.

As the check 8 is further transported at a prescribed speed, signals pertaining to the magnetic ink are generated and stored in the storage device at predetermined intervals. The magnetic head 52 detects magnetic noise even after the trailing edge of the check 8 has passed over the magnetic head 52. The average of the magnetic noise level pertaining to the blank area and the magnetic noise pertaining to the ink-applied area is calculated and used as background signal level. This calculation can be accomplished by any known signal processing apparatus. The distance between the reading mechanism 5 and the nip between the sheet-transporting rollers 31 and 32 should better be shorter than the trailing edge and the ink-applied area. This is because data is read from the magnetic ink as the check 8 is transported backwards after transported forwards before its trailing edge leaves the transporting mechanism 3.

After the check 8 is transported to the position where the printing mechanism 4 starts printing endorsement data, the self-hold solenoid moves the pressing roller 51 from the magnetic head 52. At the same time, the background signal level is subtracted from the signal level pertaining to the magnetic ink, thus acquiring detection data. Using the detection data, the magnetic ink characters are decrypted by the known method and the characters decrypted are transmitted to the host apparatus. The host apparatus transmits the data represented by the magnetic ink characters to the bank or the like that has issued the check 8, inquiring the bank about the validity of the check 8. Upon receiving a reply from the bank, indicating the validity of the check 8, the host apparatus transmits the reply to the data reading apparatus.

FIG. 4 illustrates an exemplary waveform of a signal that the data reading apparatus generates upon reading magnetic ink characters. The magnetic ink character shown in the left half of FIG. 4 is number “3,” and the magnetic ink character shown in the right half of FIG. 4 is number “1.” The font of MICR characters is defined in the Specification of Magnetic Ink Characters E13B (JIS C 6251). When the characters are scanned in the direction of arrow A (see FIG. 4) with a magnetic head having a gap length of, for example, 0.076 millimeters and being moved at a relative speed of about 4 meters per second, the magnetic head generates a signal having the waveform shown in FIG. 4. In FIG. 4, p1 and p2 are peaks of the signal waveform pertaining to each character, and m1 and m2 are valleys of the signal waveform. From the positions peaks p1 and p2 and the valleys m1 and m2 assume on the time axis, the character is recognized. Therefore, if the peaks and valleys shift more than tolerance values, the character cannot be correctly recognized.

In FIG. 4, Swp is amplitude above the base line, and Swm is amplitude below the base line. The two amplitudes define the amplitude of the signal waveform. The signal amplitude is not limited to the sum of Swp and Swm, nonetheless. In practice, the signal amplitude may be Swp, Swm, the greater of these, or the average of these.

Data reading apparatuses differ in operating characteristic. Thus, the signals two apparatuses generate upon reading the same check have different signal waveforms. One of the factors responsible for this is the difference in the operating characteristic of the transporting system. That is, one data reading apparatus differs from another, in the circularity of the sheet-transporting rollers, the distance the medium moves during one rotation of motor shaft, the coefficient of friction with the medium, and the like.

Moreover, the operating characteristic of the transporting system of each data reading apparatus may change with time. In this case, the signals the apparatus generates from the same check at different times have different waveforms, each shifting in the direction of the time axis (see FIG. 4). Consequently, the apparatus will fail to read data correctly from check.

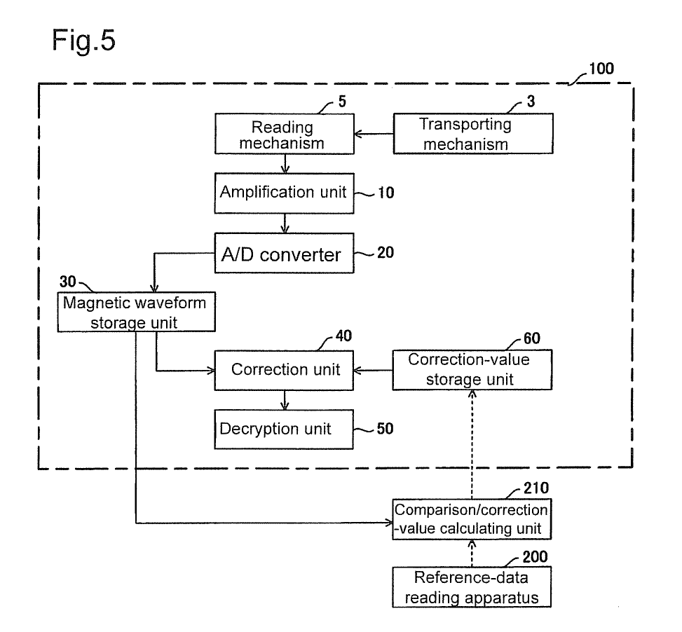

This is why the data reading apparatus according to the embodiment of this invention has a correction means to eliminate reading errors due to the changes in the operating characteristic of the transporting system. The apparatus having the correction means that processes the data read from magnetic ink characters will be explained with reference to FIG. 5. FIG. 5 is a block diagram showing an exemplary configuration of the data reading apparatus 100 according to the embodiment of this invention.

The data reading apparatus 100 includes an amplification unit 10, an A/D converter 20, a magnetic waveform storage unit 30, a correction unit 40, a decryption unit 50 and a correction-value storage unit 60, in addition to the major components, e.g., the transporting mechanism 3 configured to transport a medium and the reading mechanism 5 including the read head. The magnetic waveform storage unit 30 is, for example, a volatile memory (RAM). The correction-value storage unit 60 is, for example, a nonvolatile memory (EEPROM). The reading mechanism 5 is arranged near the transporting mechanism 3 of the medium, as described above. The magnetic head 52 reads data from the magnetic ink characters printed on a medium, generating magnetic waveform data. The reading mechanism 5 outputs the magnetic waveform data to the amplification unit 10. The amplification unit 10 amplifies the signal so that the magnetic ink characters may be easily decrypted. The magnetic waveform data amplified is supplied to the A/D converter 20. The A/D converter 20 performs analog-to-digital conversion on the data, converting the data to signal waveform in which each change in a magnetic field is represented by, for example, 10 bits. The A/D converted magnetic waveform data is supplied to, and stored in, the magnetic waveform storage unit 30. The magnetic waveform data stored in the unit 30 is supplied to the correction unit 40.

A reference-data reading apparatus 200, which is shown in FIG. 5, will be described. The reference-data reading apparatus 200 is configured to output magnetic waveform data that accords with specific standards, when it reads magnetic ink characters according to the standards, too, and printed on a standard medium being transported by the medium transporting system, if the medium transporting system is a model appropriately manufactured and controlled. Therefore, the reference-data reading apparatus 200 can be the not to differ, in basic configuration, from the data reading apparatus 100. As pointed out earlier, the data reading apparatus 100 has an individual difference. Inevitably, the magnetic waveform it generates from the same standard medium is different from the magnetic waveform the reference-data reading apparatus 200 reads. Hence, as may be seen from FIG. 5, a comparison/correction-value calculating unit 210 compares the reference magnetic waveform the reference-data reading apparatus 200 has read from a reference medium with the magnetic waveform the data reading apparatus 100 has actually read from the reference medium. The reading error of the apparatus 100 is thereby determined. From the reading error thus determined, a correction value is calculated for the data reading apparatus 100. The correction value is stored into the correction-value storage unit 60 in advance. In order to acquire a correction value as appropriate as possible, it is desirable that the apparatus 100 should read the reference medium more than once. For example, the reference medium may be read three to five times, obtaining three to five correction values so as to determine a correction value. In this case, the correction value may be an arithmetic mean of these correction values temporarily calculated for each reading or the central value thereof.

The correction unit 40 performs a correction process on the magnetic waveform data stored in the magnetic waveform storage unit 30, by using the correction value for the apparatus 100, which has been supplied from the correction-value storage unit 60. The correction process is performed to compensate for the shift of magnetic waveform in the direction of the time axis. The magnetic waveform data corrected by the correction unit 40 is supplied to the decryption unit 50. The decryption unit 50 decrypts the characters printed in magnetic ink on the recording medium, e.g., a check.

The correction and character decryption performed in the correction unit 40 and decryption unit 50, respectively, can be achieved by using process programs. Alternatively, the correction unit 40 and decryption unit 50 maybe embodied in the form of a single program. If this is the case, the program is installed in a solid-state memory of known type.

The sequence of storing the correction value will be explained below.

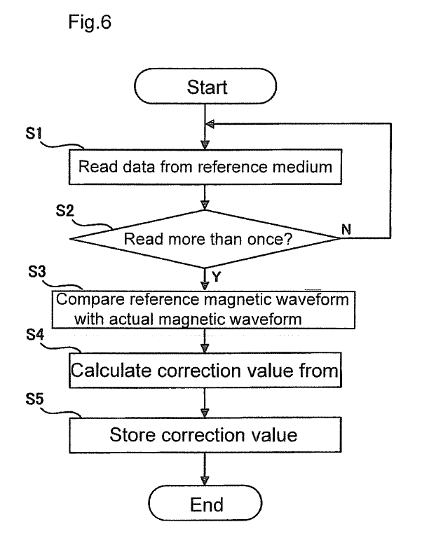

FIG. 6 is a flowchart explaining the sequence of storing the correction value in the data reading apparatus according to the embodiment of the invention. First, the data printed on the reference medium is read in Step S1. Then, in Step S2, whether the data has been repeatedly read a specific number of times is determined. If NO in Step S2, the flow will return to Step S1. If YES in Step S2, the flow goes to Step S3. In Step S3, the reference magnetic waveform is compared with the magnetic waveform actually read from the reference medium, finding a reading error. In Step S4, a correction value is calculated from the reading error. In Step S5, the correction value is stored into the correction-value storage unit 60.

As described above, the data reading apparatus 100 transmits the data representing the magnetic ink characters to the host apparatus (not shown). The host apparatus transmits the data to the bank or the like that has issued the check, inquiring the bank about the validity of the check. Upon receiving a reply from the bank, indicating the validity of the check, the host apparatus transmits the reply to the data reading apparatus 100. In the data reading apparatus 100, the printing mechanism can perform endorsement process on the check.

In the present embodiment so configured as described above, magnetic waveform corrected to compensate from the transporting error inherent to the apparatus can be acquired. The magnetic waveform so corrected is used to decrypt the magnetic ink characters printed on the recording medium. The reading error resulting from the difference in the operating characteristic of the apparatus can therefore be minimized. In addition, the precision of reading the magnetic ink characters recorded in recording medium can be increased, because the medium-transporting characteristic specific to the apparatus need not be taken into consideration in the process of analyzing the magnetic waveform.

It should be noted that the present invention is not limited to only the embodiment described above. The components of the embodiment can be modified in various manners in reducing the invention to practice, without departing from the sprit or scope of the invention. Further, the components of the embodiment described above may be combined, if necessary, in appropriate ways, thereby to make different inventions. For example, some of the component of the embodiment may not be used. Moreover, the components of possible different embodiments of the invention may be combined in any desired fashion.

What is claimed is:

1. A data reading apparatus comprising:
a medium-transporting unit configured to transport a medium on which magnetic ink characters are printed;
a reading mechanism configured to read the magnetic ink characters printed on the medium in the form of a magnetic waveform;
a correction-value storage unit configured to store a correction value inherent to the data reading apparatus, the correction value having been calculated from an error determined by comparing a reference magnetic waveform acquired by reading reference magnetic ink characters printed on a reference medium in a reference data reading apparatus, with the magnetic waveform actually acquired by reading the reference medium by the reading mechanism;
a correction unit configured to correct, by using the correction value, the magnetic waveform acquired when the reading mechanism actually reads the magnetic ink characters printed on the medium; and
a decryption unit configured to decrypt the magnetic ink characters printed on the medium, in accordance with the magnetic waveform corrected by the correction unit.

2. A data reading apparatus comprising:
a medium-transporting unit configured to transport a medium on which magnetic ink characters are printed;
a reading mechanism configured to read the magnetic ink characters printed on the medium in the form of a magnetic waveform;
a reference magnetic waveform storage unit configured to store a reference magnetic waveform acquired by reading reference magnetic ink characters printed on a reference medium in a reference data reading apparatus;
an actual magnetic waveform storage unit configured to store an actual magnetic waveform read from the reference medium;
a correction-value storage unit configured to store a correction value obtained by comparing the reference magnetic waveform with the actual magnetic waveform, as a correction value inherent to the data reading apparatus;
a correction unit configured to correct, by using the correction value, the magnetic waveform acquired when the reading mechanism actually reads the magnetic ink characters printed on the recording medium; and
a decryption unit configured to decrypt the magnetic ink characters printed on the medium, in accordance with the magnetic waveform corrected by the correction unit.

3. The data reading apparatus according to claim 1, further comprising
an amplification unit configured to amplify the read magnetic waveform, and an A/D converter configured to perform A/D conversion on the amplified magnetic waveform.

4. The data reading apparatus according to claim 2, further comprising
an amplification unit configured to amplify the read magnetic waveform, and an A/D converter configured to perform A/D conversion on the amplified magnetic waveform.

5. The data reading apparatus according to claim 1, wherein
the correction value has been determined by reading the reference medium more than once.

6. The data reading apparatus according to claim 2, wherein
the correction value has been determined by reading the reference medium more than once.

7. The data reading apparatus according to claim 5, wherein
the correction value has been determined by reading the reference medium three to five times.

8. The data reading apparatus according to claim 6, wherein
the correction value has been determined by reading the reference medium three to five times.

9. The data reading apparatus according to claim 1, wherein
the error is a shift of the read magnetic waveform in the direction of the time axis.

10. The data reading apparatus according to claim 2, wherein
the error is a shift of the read magnetic waveform in the direction of the time axis.

11. The data reading apparatus according to claim 3, wherein
the A/D converter converts a magnetic-field change reflected in the read magnetic waveform to a signal waveform represented by 10 bits.

12. The data reading apparatus according to claim 4, wherein
the A/D converter converts a magnetic-field change reflected in the read magnetic waveform to a signal waveform represented by 10 bits.

13. The data reading apparatus according to claim 1, wherein
the error has resulted from an advance or delay of the recording medium with respect to the reference medium transported in the reference data reading apparatus, the advance or delay having been resulted from the circularity of the sheet-transporting rollers of the medium-transporting unit or from the distance the medium moves during one rotation of the shaft of the drive motor of the medium-transporting unit.

14. The data reading apparatus according to claim 2, wherein
the error has resulted from an advance or delay of the recording medium with respect to the reference medium transported in the reference data reading apparatus, the advance or delay having been resulted from the circularity of the sheet-transporting rollers of the medium-transporting unit or from the distance the medium moves during one rotation of the shaft of the drive motor of the medium-transporting unit.

15. A method of controlling a data reading apparatus, comprising:
storing an error as a correction value inherent to the data reading apparatus, the error having been determined by comparing a reference magnetic waveform acquired by reading reference magnetic ink characters printed on a reference medium in a reference data reading apparatus, with a magnetic waveform actually acquired by reading the reference medium by a reading mechanism;
correcting, by using the correction value, the magnetic waveform acquired when the reading mechanism actually reads the magnetic ink characters printed on the medium; and
decrypting the magnetic ink characters printed on the medium, in accordance with the magnetic waveform corrected.

16. The method according to claim 15, wherein
the correction value has been determined by reading the reference medium more than once.

17. A printer comprising a data reading apparatus that comprises:
a medium-transporting unit configured to transport a medium on which magnetic ink characters are printed;
a reading mechanism configured to read the magnetic ink characters printed on the medium in the form of a magnetic waveform;
a correction-value storage unit configured to store a correction value inherent to the data reading apparatus, the correction value having been calculated from an error determined by comparing a reference magnetic waveform acquired by reading reference magnetic ink characters printed on a reference medium in a reference data reading apparatus, with the magnetic waveform actually acquired by reading the reference medium by the reading mechanism;
a correction unit configured to correct, by using the correction value, the magnetic waveform acquired when the reading mechanism actually reads the magnetic ink characters printed on the medium; and
a decryption unit configured to decrypt the magnetic ink characters printed on the medium, in accordance with the magnetic waveform corrected by the correction unit.

18. A printer comprising a data reading apparatus that comprises:
a medium-transporting unit configured to transport a medium on which magnetic ink characters are printed;
a reading mechanism configured to read the magnetic ink characters printed on the medium in the form of a magnetic waveform;
a reference magnetic waveform storage unit configured to store a reference magnetic waveform acquired by reading reference magnetic ink characters printed on a reference medium in a reference data reading apparatus;
an actual magnetic waveform storage unit configured to store an actual magnetic waveform read from the reference medium;
a correction-value storage unit configured to store a correction value obtained by calculating from an error determined by comparing the reference magnetic waveform with the actual magnetic waveform, as a correction value inherent to the data reading apparatus;
a correction unit configured to correct, by using the correction value, the magnetic waveform acquired when the reading mechanism actually reads the magnetic ink characters printed on the medium; and
a decryption unit configured to decrypt the magnetic ink characters printed on the medium, in accordance with the magnetic waveform corrected by the correction unit.

19. The printer according to claim 17, wherein
the data reading apparatus further comprises an amplification unit configured to amplify the read magnetic waveform, and an A/D converter configured to perform A/D conversion on the amplified magnetic waveform.

20. The printer according to claim 17, wherein, in the data reading apparatus, the correction value has been determined by reading the reference medium more than once.
